(19) United States
(12) Patent Application Publication
(10) Pub. No.: US 2013/0299265 A1
(43) Pub. Date: Nov. 14, 2013

(54) ELECTRIC MOTORCYCLE

(71) Applicant: Lawrence Marazzi, London (GB)

(72) Inventor: Lawrence Marazzi, London (GB)

(73) Assignee: AGILITY GLOBAL LTD, London (GB)

(21) Appl. No.: 13/983,372

(22) PCT Filed: Feb. 3, 2012
(86) PCT No.: PCT/GB12/00114

§ 371 Date: Aug. 2, 2013

(30) Foreign Application Priority Data
Feb. 3, 2011 (GB) 1101879.3

(51) Int. Cl. B62K 11/00

(52) U.S. Cl. CPC B62K 11/00
USPC 180/220

(57) ABSTRACT

An electric motorcycle includes a front wheel and front suspension, a rear wheel and rear suspension, an electric motor with a transmission that provides motive force to the rear wheel and a composite monocoque structure extending between the front suspension, and the rear suspension and motor, which house a plurality of electric batteries. The monocoque structure may include internal partitions to provide increased strength or stiffness, these partitions creating compartments to separate the batteries. The batteries are arranged in one or more rows, each row being aligned with the axis between the mounting of the front suspension on the monocoque structure and the mounting of the rear suspension and motor on the monocoque structure.

This invention relates to electric motorcycles, particularly high performance electric motorcycle.

Designing an electric motorcycle includes several challenges that over a conventional motorcycle powered by petrol. Batteries generally have a lower energy density than petrol, so that to achieve the same performance in terms of both speed and range of travel, a large proportion of the weight and volume of the motorcycle must be devoted to the batteries. This adds to the total weight of the motorcycle and is detrimental to the speed and range of the motorcycle.

To achieve good performance, it is important to minimise the weight of the motorcycle as a whole, while retaining sufficient strength to support the motorcycle's components.

It is an object of the present invention to provide an electric motorcycle having a low weight and good performance.

According to the present invention there is provided an electric motorcycle comprising

a front wheel and front suspension
a rear wheel and rear suspension
an electric motor having a transmission that provides motive force to the rear wheel
a composite monocoque structure extending between the front suspension, and the rear suspension and motor
the monocoque structure housing a plurality of electric batteries.

According to other aspects of the invention, there are provided motorcycles as defined in independent claims 2 to 17.

An embodiment of the invention will now be described with reference to the drawings, of which;

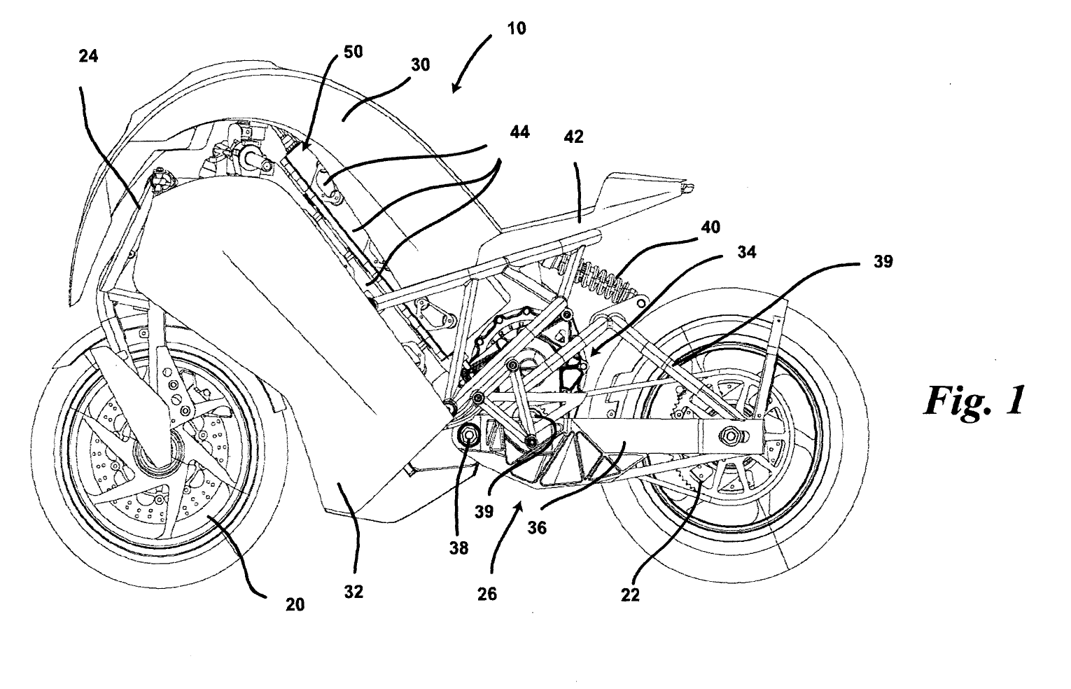

FIG. 1 shows a side elevation of a motorcycle

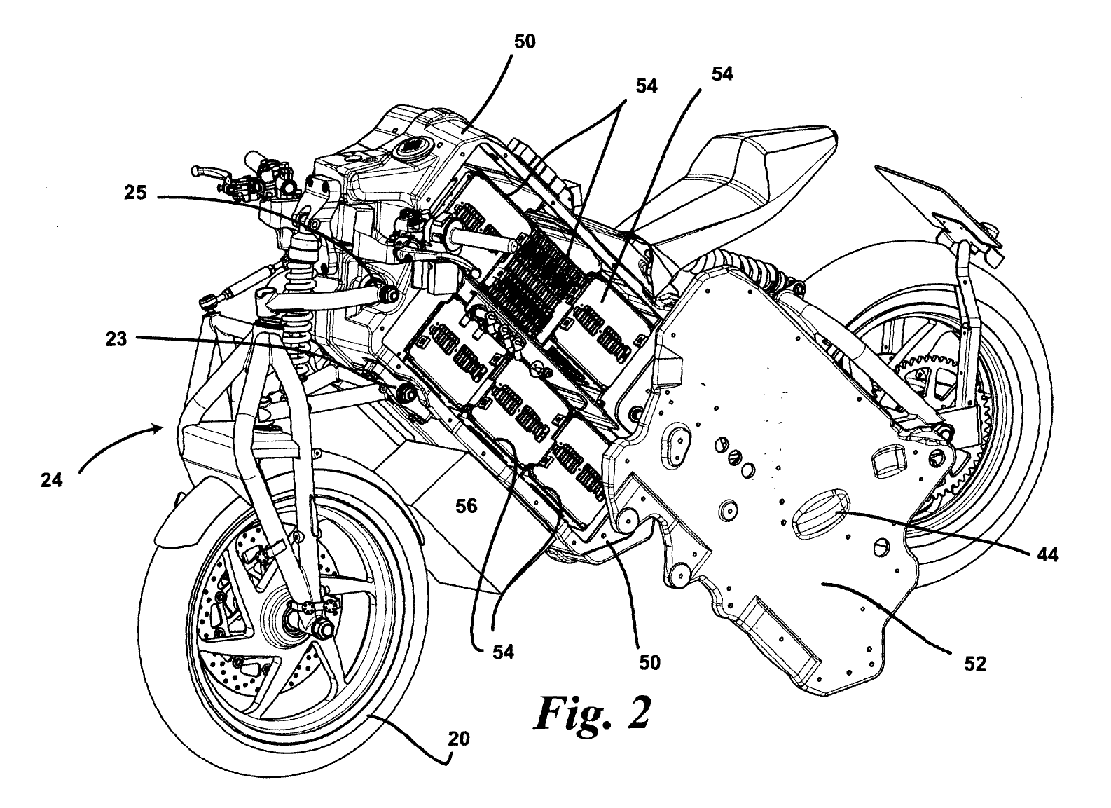

FIG. 2 shows a perspective view of the motorcycle with some parts removed

FIG. 2a shows an enlarged view of part of the motorcycle shown in FIG. 2

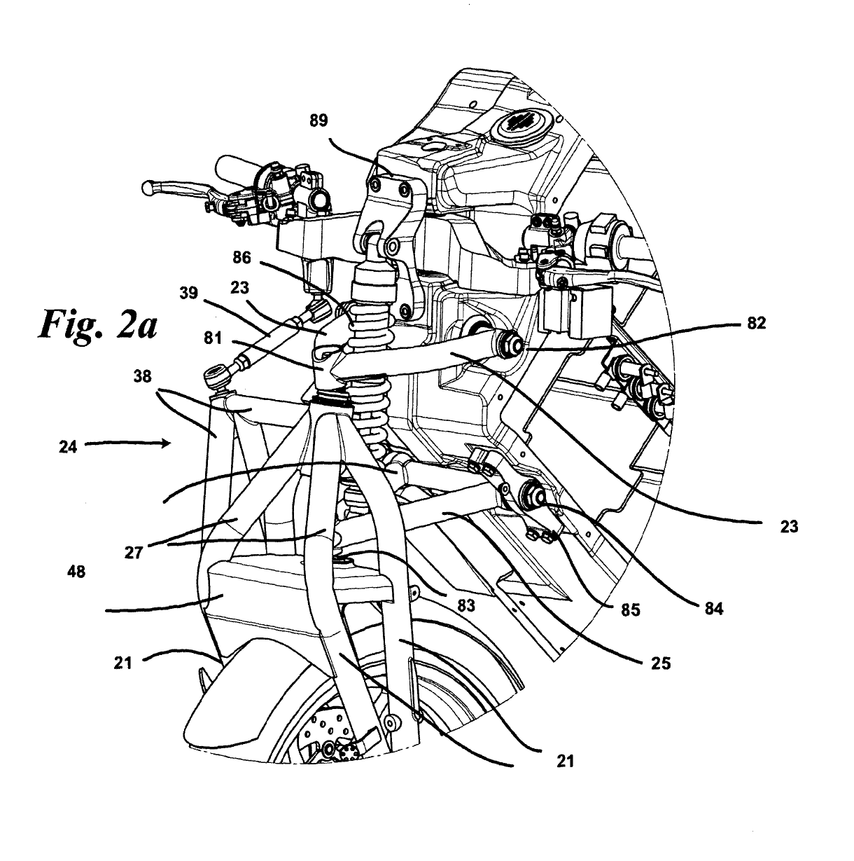

FIG. 3 shows a partly exploded perspective view of the motorcycle

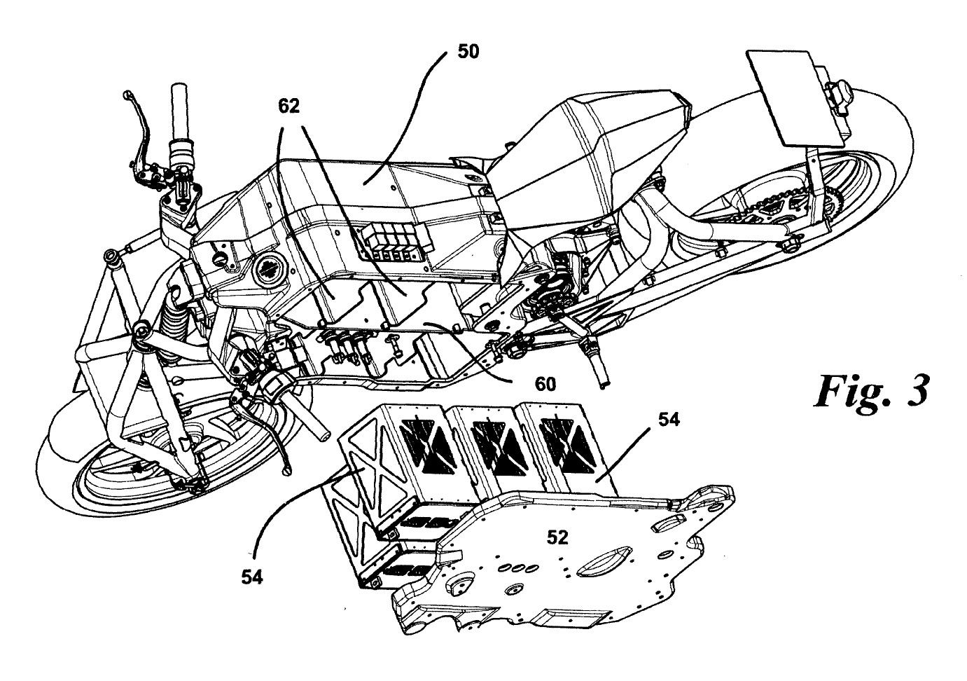

FIG. 4 shows a partly exploded perspective view of the motorcycle.

Referring to FIG. 1, a motorcycle 10 comprises front and rear wheels 20, 22, connected to front and rear suspensions 24, 26 respectively, linked by a chassis. The chassis is formed from a monocoque frame 50 and the motor and transmission 34. The monocoque frame is covered by a top fairing 30 and side fairings 32.

The monocoque frame 50 can be seen more clearly in FIG. 2 and subsequent drawings. Referring to FIG. 2, the monocoque frame is formed as a shaped box-like structure from a composite material, such as a resin and carbon fibre structure. This can be easily accurately shaped using a one-step moulding processes, which can be sealed. A variety of techniques from hand layup through resin transfer moulding through injection moulding may be employed. The monocoque frame also ideally includes a honeycomb layer, the walls of the honeycomb cells standing perpendicular to the skin of the monocoque frame.

The monocoque frame 50 is hollow, the internal volume including space for the batteries 54. Six batteries are shown in the present embodiment, arranged in two rows of three, the upper row being position in an offset manner slightly forward of the lower row when considered in the plane of the rows. The shape of the monocoque frame in this design has been chosen to largely conform to the batteries. Since the monocoque frame is based on cuboid (indeed they may be almost cubic) batteries, the frame shape has a considerable width and height when considered along its main axis, in addition to its length which extends from the front suspension to close to a rear swingarm pivot point 38 on the motor. The maximal cross sectional area across all three principal axes, in particular a very wide cross section along the principle axis of load transmission between front suspension and rear suspension, gives the frame an inherently high stiffness to weight ratio. Also interior bulkheads give rigidity. Referring again to FIG. 1, the lower part of the monocoque frame 50 is shaped to fit against and engage with the motor and transmission 34.

Referring to FIGS. 3 and 4, the monocoque frame 50 has an internal bulkhead 60 extending between the two rows of batteries 54, and further internal bulkheads 62 separating each battery in a row from the neighbouring battery or batteries. The bulkheads provide additional stiffness, particularly torsional stiffness. The monocoque frame 50 and batteries 54 are enclosed on each side by a lid 52. The monocoque frame 50 also has mounting inserts bonded to it, which allow the motorcycle's other components to be attached to the top and side frames using bolts or similar fasteners.

Each lid 52 is formed of composite material in the same way as the main monocoque frame 50, and when fixed to the monocoque frame 50 together form a unitary enclosed monocoque structure. The lids 52 themselves contribute to the strength and stiffness of the chassis, particularly in a vertical plane along the axis of the motorcycle.

Being manufactured from such a composite material, the battery boxes formed by the monocoque frame 50 and lids 52 which house the batteries can straightforwardly be manufactured to be watertight.

The monocoque frame can of course house different numbers or arrangements of batteries using such a modular system, typically 3, 6, 8 or 12 batteries arranged in one or two rows. The modular structure makes for improved serviceability, and manufacturing efficiency. The entire battery management system is housed within the modules, allowing for the removal or addition of batteries simply and quickly.

The removal of the lid 52, gives access to the battery bays from one side of the bike without the need to disassemble any of the suspension or primary structures of the motorcycle. This gives a massive improvement to serviceability and ease of assembly on the production line. The lid may be secured Although the lids contribute to the stiffness and strength of the chassis, the main monocoque frame 50 is itself stiff enough for partly assembled bikes to be wheeled during assembly without the need for mobile jigs or frames.

The accessibility of batteries for service or changing during long term or trip use can be further improved by adapting the battery lid to allow palletization of the modules, such that when the lid is removed, the modules are removed with it, the batteries or battery modules being connected through fast connectors such that when the lid is re-attached, the batteries are automatically electrically connected to the motorcycle's power distribution system. This allows fast-changing of the battery pack if required, such as under race conditions. This can be reduced to a matter of 20-50 seconds.

The lid of the battery bays of the monocoque frame forms a major structural component and forms the dual function of sealing the monocoque frame and acting as one of the primary structural skins of the monocoque frame.

Different arrangements of lid are possible, such a single lid as shown in FIGS. 2 to 4, or a double bay arrangement where two lids each give access to a separate row of batteries. The lid may be attached, for example, using quick release bolts to the monocoque frame, or could be provided with a hinge. The lids could be provided with handles 44.

In allowing a very high volume fraction of batteries, this also allows the bike to remain small and compact. The battery volume of the main monocoque frame and lid which together make up the monocoque structure can be in excess of 80%. Thus improving handling due to the use of a shorter wheel base, improve changes of direction, reduced weight overall of vehicle by allowing a lower quantity of material and the shorter wheel base allowing a higher torsional rigidity to be achieved. In addition, the higher capacity of batteries allows greater current output, giving greater power, acceleration and range as befits a performance motorcycle. Whereas moped and scooter type bikes experience relatively small forces and overcome this using rigid and heavy material, a performance bike may experience 1.6-2 tons of force through either its front or rear suspension to the chassis at any one time.

Also, for a performance bike, a large number of batteries equate to a large weight, so the provision of a stiff, lightweight frame is especially important to achieve an electric performance bike. Typically, the batteries may weigh 72 kg compared to a monocoque frame of 22 kg, and a total motorcycle weight of 175 kg.

In addition, minimising the heat input into the monocoque frame also reduces the need to control the thermal environment to protect the battery cells, which may require heat dissipation during high discharge operation.

Composite and interior skin may be used in order to mitigate any possibility of fire or electrical danger.

The battery packaging incorporates high-level environmental protection. The entire sub-packs of each battery 54 are sealed to IPH66/IPH67 level protection against water and environmental contaminants. To address safety issues, isolation of all high power connections are placed internally within sub-packs. The system also incorporates thin aluminium films which act as both heat sink and start-up heater.

The 2-stage cell module pack system also functions as a high capacity heat-sink. This system incorporates two functions. The first is a highly effective thermal conductive path away from the cells to prevent overheating during operation. The second function is that the system conversely achieves high thermal insulation. Due to the insulation function, it gains low-energy heat-up to operating temperature under extreme low temperature conditions. Thus the system efficiently manages both extremes of the cell operating temperature range.

The 2-Stage cell module pack system also achieves both penetrative impact resistance, and pack macro deformation resistance to IMO standard. Pouch cells are vulnerable to external mechanical damage and the 2-Stage cell module/module pack design prevents such possibilities. High-level Impact Energy Modulation and Control can also be provided, the control system being designed to minimise deceleration/acceleration spikes during impact events.

Referring back to FIG. 2, the front wheel 20 is mounted in a double wishbone suspension 24. The axle of the front wheel 20 is mounted on lower forks 21 on a fork subframe assembly 27. The fork assembly 21 is coupled to the monocoque frame 50 by an upper wishbone 25 and a lower wishbone 23. The upper wishbone 23 comprises a bifurcated pair of struts which meet at a universal joint 81 on the fork subframe assembly, and each strut is attached to the monocoque frame 50 at a pair of mounting inserts 82. The lower wishbone 25 similarly comprises a pair of struts that meet at a universal joint 83 attaching the lower wishbone 25 to the fork subframe assembly 27, and which are attached to either side of the monocoque frame 50 at a fixing points 84. The fixing points may themselves be spaced from the monocoque frame 50 e.g. by brackets 85.

The fork subframe assembly 27 also includes a steering frame 38, so that the handlebars are coupled to the fork subframe assembly 27 by a steering rod 39. Shock absorption is provided by a spring and damper mounted between the fork subframe assembly 27 and (via a head bracket 89) the monocoque frame 50. Unlike a telescopic steering column, the suspension and steering are separated in this front suspension. It will be realised that the joints and struts may be varied to provide other suspension frameworks that provide four or more coupling points to the monocoque frame 50.

The frame cross section is designed to both maximize internal volume and match the width of the front and rear suspension inboard mounting points, the multiple connection points of the front double wishbone suspension are ideally suited for such a design. Because of the matched width, the front and rear inboard mounting points of the suspension transmit their load into the skins of the monocoque in the most efficient manner structurally. The mounting points arrange the shape of the monocoque such that the inboard suspension loads are transmitted principally into the monocoque parallel to the surfaces of the monocoque. This is more efficient than would be the case of fork-type front suspension through a single pivoting axis as in a conventional motorcycle.

Thus the front suspension is attached to double wishbones 23, 25 at four points on the monocoque frame 50 provided by mounting inserts widely spaced both laterally and vertically from each other. This allows the load transmitted from the front wheel to be distributed laterally on the monocoque frame skin in an efficient manner. A thin shell provided by a monocoque frame skin withstands forces more effectively when the force is transmitted in the plane of the skin. Thus the use of a multiple contact points of a double wishbone suspension is more stable using a fork-type suspension in a telescopic steering column, which is typically mounting on a motorcycle frame at two points. Also, points at which the steering column bear against the wishbone can be spaced further apart, thereby reducing the moment of force exerted by the front suspension on its bearing points as the bike brakes, which tends to cause the bike to dive.

Attached the front suspension 24 to the side frame using bolts to the mounting inserts means that no heating or welding is required during assembly. This avoids distortion and changes to the stability and tolerance of the assembled parts due to thermal input that would be incurred by use of a welding process. The entire structure is not subject to any form of thermal defamation to join it, and relies instead on accurate tooling and moulds.

In additional to the structural stiffness and stability provided by the monocoque frame, fewer parts and less construction is required than is the case for a motorcycle frame composed of for example tubular strutwork, while the monocoque frame provides good impact protection of sensitive electronic systems, and good sealing from water, environmental factors, and foreign contaminants. The stiffness of the frame also aids direct actuation of the motorcycle's suspension, which is described in more detail below.

A particular advantage of a composite monocoque frame is the weight saving over a metal strutwork frame or machine cut metal sheet. The lower weight gives better energy efficiency, mitigating the weight of the batteries, and also improves the speed of changes in direction, and the acceleration and breaking, and lowers the wear and tear on brakes, tyres, and charger system due to lower load on each part.

The motor 24 is attached to the top frame 30 and side frame 32, again using bolts that engage with mounting inserts provided in the frames 30, 32. The rear wheel 22 is structurally connected to the motor by a swing arm 36 mounted on a pivot point 38 on the motor. Stiffness is provided by a framework 38 connected to a shock absorber 40 mounted beneath the seat 42 and top frame 30.

It will be noted that this arrangement concentrates the major masses of the motorcycle, the batteries and the motor, closely around the centre of gravity of the bike. This reduces the polar moment of inertia of the bike about all three axes, meaning that less work is required to change the bike's directions of travel, that is, which improves the bike's handling. The weight of the batteries are spread over the monocoque frame using the bulkhead or tab structure at multiple points, typically nine key load points. The monocoque frame provides a large internal volume for the batteries; a larger battery volume allowing more energy to be stored and therefore better performance.

The motor 34 is kept outside of the frame for improved cooling. For a high performance motorcycle, the necessity to dissipate heat from the motor is critical. Mounting the motor externally to the battery box gives an improvement over the U.S. patent as it has a massively greater ability to dissipate heat. Also the motor cannot directly radiate or dissipate heat to the inside of the monocoque frame structure to compromise the effectiveness, performance and life of the battery management system, and other high voltage electronics.

The motor 34 is rigidly mounted as a structural stressed member to the monocoque frame and directly is part of the structure that supports the final drive transmission system. This eliminates the need for an additional transmission or motor subframe or mounting system. This maximises the structural efficiency through the whole motorcycle. The gearbox in turn is rigidly mounted to the motor as a structural stressed member.

Referring to FIG. 1, the swingarm 36 of the rear suspension 26 is mounted on a pivot point 38 that is located forward of the motor output and final chain drive 39. Mounting the swingarm pivot 38 non-coaxially and forward of the motor output and final chain drive 39 reduces chain tension changes during suspension deflection to a level below 5 mm throughout the range of suspension movement. This negates the need for any form of tension idler and reduces complexity, cost, parts count and weight. Thus, this arrangement achieves a good rising rate anti squat characteristics during acceleration of the motorcycle.

Similarly, if the suspension pivots between the motor and the wheel centre, a further increase in the falling rate tendency to resist squat will occur. The geometry of the present system improves on both these options whilst eliminating the need for additional components. A transmission is included to allow placement of the output sprocket in the ideal location and to allow variation of output speed of the motor dependent on a transmission ratio of this unit. In addition, this unit can contain a 2 or 3 speed epicyclic type transmission to allow for changes in speed of the motorcycle.

This arrangement maintains overall handling and performance efficiency, and maintains wheel contact patch to wheel contact patch system wide structural rigidity. It is critical to the handling of the machine. Using the present arrangement, the motor is raised into a position, though overlapping with the swing arm, that allows the swing arm to maintain an efficient structural shape and cross section to give a high structural rigidity and efficiency. This reduces the mass of the swing arm while still achieving high torsional rigidity necessary for good handling.

Referring to FIG. 2, the battery charger 56 is mounted externally to the monocoque frame and directly to the monocoque frame, for example using moulded inserts in the monocoque frame. It is located again as close to the optimal centre of gravity as possible to allow maximum concentration of masses of the vehicle in order to improve direction changes, handling and manoeuvrability. In addition, to allow cooling of said charger during charger operation and again so as not to close heat within the monocoque frame, which could create negative heat effects to battery systems. Installing the charger within the monocoque frame could cause charger temperature to rise critically and require additional charger cooling systems, adding complexity, weight and cost. This is particularly significant when fast charging is used where the charger must handle very high current transmission.

1. An electric motorcycle comprising:
a front wheel and front suspension;
a rear wheel and rear suspension;
an electric motor having a transmission that provides motive force to the rear wheel; and
a composite monocoque structure extending between the front suspension, and the rear suspension and motor;
the monocoque structure housing a plurality of electric batteries.

2. A motorcycle according to claim 1, wherein the monocoque structure includes internal partitions to provide increased strength or stiffness, these partitions creating compartments to separate the batteries.

3. A motorcycle according to claim 1, wherein the batteries are arranged in one or more rows, each row being aligned with the axis between the mounting of the front suspension on the monocoque structure and the mounting of the rear suspension and motor on the monocoque structure.

4. A motorcycle according to claim 1, wherein the monocoque structure comprises a main body and one of more panels, the panels forming part of the skin structure of the monocoque when attached to the main body, but being removable to allow access to the batteries.

5. A motorcycle according to a claim 4, wherein the removable panel seals the batteries against environmental contaminants or water, and/or to provide impact protection and/or sealing, and/or heat and/or electrical insulation, within the monocoque structure.

6. A motorcycle according to claim 1, wherein the batteries are individually sealed against environmental contaminants or water, and/or to provide impact protection and/or sealing, and/or heat and/or electrical insulation.

7. A motorcycle according to claim 1, comprising a charger for the batteries, the charger being attached externally to the monocoque structure.

8. A motorcycle according to claim 1, wherein the monocoque structure is attached to the motor, and wherein the rear suspension is attached to the motor, such that the monocoque structure and the motor form a structural component.

9. A motorcycle according to claim 8, wherein the motor is attached to a gearbox and the rear suspension is attached to the gearbox, such that the monocoque structure, motor and gearbox form a structural component.

10. A motorcycle according to claim 1, wherein the front suspension includes a double wishbone assembly, such that each wishbone secured to the monocoque structure by at least two fixing points.

11. A motorcycle according to claim 1, wherein the rear suspension comprises a swingarm, and the motor includes an output means that drives a chain or the like which in turn drives the rear wheel;
the swingarm being pivotally mounted on the chassis at a point forward of the axis of the output means.

12. A motorcycle according to claim 1, wherein the composite monocoque structure is produced by resin transfer moulding.

13. An electric motorcycle comprising:
a front wheel and front suspension;
a rear wheel and rear suspension;
an electric motor;
a monocoque structure housing electric batteries; and
a motor having a transmission that provides motive force to the rear wheel, the monocoque structure being attached to the motor, and the rear suspension being attached to the motor, such that the monocoque structure and the motor form a structural component.

14. An electric motorcycle comprising:
a front wheel and front suspension;
a rear wheel and rear suspension;
an electric motor; and
a monocoque structure housing electric batteries;
the front suspension comprising a double wishbone, the upper part of each wishbone being attached to the monocoque structure by at least two fixing points.

15. An electric motorcycle comprising:
a front wheel and front suspension;
a rear wheel and rear suspension;
an electric motor; and
a monocoque structure housing electric batteries;
the monocoque frame being divided into cuboid cavities for the storage of batteries.

16. A motorcycle comprising:
a front wheel and front suspension;
a rear wheel and rear suspension, the rear suspension including a swingarm a chassis; and
a motor having an output means that drives a chain or the tike which in turn drives the rear wheel;
the swingarm being pivotally mounted on the chassis at a point forward of the axis of the output means.

17. An electric motorcycle comprising:
a front wheel and front suspension;
a rear wheel and rear suspension;
an electric motor;
a monocoque structure housing electric batteries; and
a motor having a transmission that provides motive force to the rear wheel the monocoque structure being composed of a honeycomb structure.
